(19) United States
(12) Patent Application Publication
(10) Pub. No.: US 2008/0068136 A1
(43) Pub. Date: Mar. 20, 2008

(54) Methods and apparatus for autoconfiguration of RFID readers

(75) Inventors: Ajay Malik, San Jose, CA (US); Puneet Batta, Santa Clara, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/515,137

(22) Filed: Aug. 31, 2006

(51) Int. Cl. H04Q 5/22; G08B 13/14

(52) U.S. Cl. 340/10.5; 340/10.1; 340/572.1

(57) ABSTRACT

An RFID reader is designed to autoconfigure itself during initial operation by reading configuration information from an RFID tag within its operational range, selecting a configuration file based on the configuration information, and configuring itself based on the configuration file. The configuration file may be stored on the reader itself, or requested and received over a network. The RFID tag may be password protected to add further security.

### TECHNICAL FIELD

The present invention relates generally to radio frequency identification (RFID) systems, wireless local area networks (WLANs), and any other network incorporating RF elements, and, more particularly, to methods of configuring RFID readers.

### BACKGROUND

Radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

Such sites often include a large number of RFID readers. When an RFID reader (and/or its antenna) becomes inoperative or otherwise needs to be replaced, a new, unconfigured RFID reader is usually installed in its place or, in the case of handheld readers, simply replaced for use by personnel moving through the environment. Configuration of RFID readers can be complex and time-consuming, and involves significant administrator involvement. For site with a large number of RFID readers, the resulting administrative costs can be very high, and the impact on the business can be significant.

Accordingly, it is desirable to provide simplified methods for replacing and installing RFID readers which require little or no administrative involvement. Other desirable features and characteristics of the present invention will become apparent from the subsequent detailed description and the appended claims, taken in conjunction with the accompanying drawings and the foregoing technical field and background.

### BRIEF SUMMARY

A system for autoconfiguration of an RFID reader includes a plurality of RFID tags (e.g., password-protected tags) distributed throughout an environment, wherein the tags include a configuration code or other such configuration information. An RFID reader is designed to autoconfigure itself during initial operation by reading configuration information from one of the RFID tags within its operational range, selecting a configuration file based on the configuration information, and configuring itself based on the configuration file. The configuration file may be stored on the reader itself, or requested and received over a network.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention; and

FIG. 2 is a conceptual overview of an RFID reader being configured in accordance with the present invention; and

FIG. 3 is a flow chart showing an example configuration process in accordance with the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates to an improved user interface for real-time location determination, configuration, and coordination of RFID as well as WLAN components. The system provides user-friendly methods of determining the location of objects, such as RFID tags and mobile units, and provides various health monitoring information (self-healing status, “heat maps” for associated antennae, redundancy group status, intrusion detection, and health statistics).

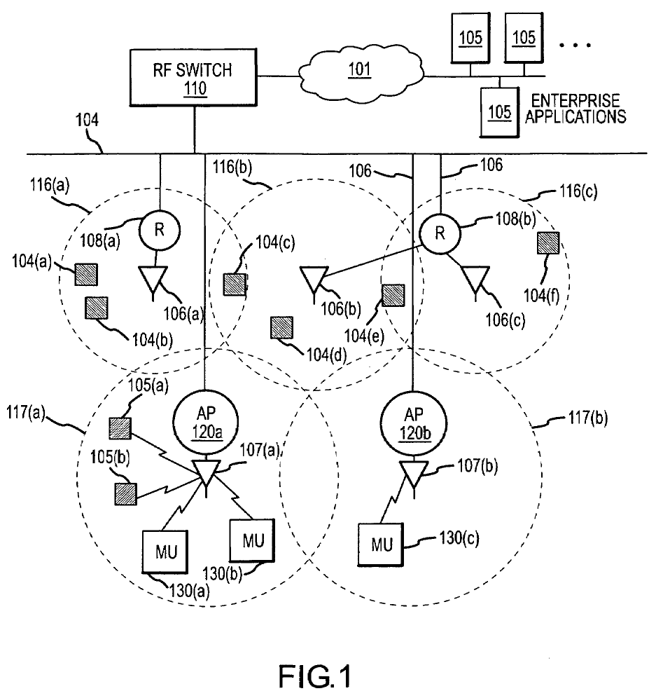

Referring to FIG. 1, in an example system useful in describing the present invention, a switching device 110 (alternatively referred to as an “RF switch” or simply “switch”) is coupled to a networks 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of RFID tags (or simply “tags”) 104 are distributed throughout the environment. These tags are read by a number of RFID readers (or simply “readers”) 108 having one or more associated antennas 106 provided within the environment. The term “tag” refers, in general, to any RF element that can be communicated with and has a ID that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 Mz apart in the RF band.

A particular RFID reader 108 may have multiple associated antennas 106. For example, as shown, in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active or passive. Active tags are devices that incorporate some form of power source (e.g., batteries, capacitors, or the like), while passive tags are tags that are energized via an RF energy source received from a nearby antenna. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1).

It is not uncommon for the RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

Switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

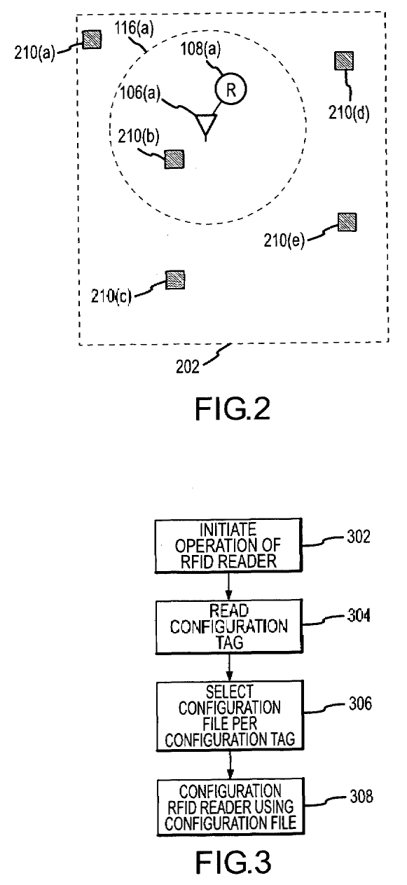

Referring to FIG. 2, a system operating in accordance with the present invention generally includes an environment 202—e.g., a store, warehouse, or any other predefined area or volume, which may of course include various doors, windows, and other points of ingress and egress. One or more RFID tags 210 are provided within the environment, wherein each of the secure RFID tags includes configuration information (preferably password-protected) that may be read by reader 108(a). RFID tags 210 are often referred to herein as simply “configuration tags.”

Configuration tags 210 are preferably distributed throughout environment 202 such that at least one of tags 210 is within the operational range of the mobile devices that are likely to be used in environment 202. In this regard, it is preferred that tags 210 are substantially stationary (e.g., secured to walls, floors, ceilings, or other internal structures), but in various embodiments may be relocated or portable, depending upon the application. In one embodiment, one or more tags 210 are placed within other electronic components within environment 202, such as wireless switches, routers, access ports, access points, and the like. Tags 210 may be distributed in a uniform, geometrical pattern (e.g., a grid), or may be placed in any suitable non-uniform arrangement that provides the desired coverage (as shown in FIG. 2). The exact positions of tags 210 may be known or unknown.

Configuration tags 210 include a configuration code or any other configuration information that may be read by an RFID reader in the conventional matter. This configuration code may be of any form. In one embodiment, the configuration tag includes an alphanumeric ID with the following fields: (1) an ID mapped on a configuration file server or RF Switch to a file name; (2) a configuration timestamp number (wherein, if this number on the tag is lower than the configuration timestamp ID of the reader configuration, then the reader does not change its configuration); (3) a configuration action number that tells the reader which action to take if it fails to retrieve the desired configuration (e.g.: continue with current configuration, continue with factory default configuration, or do not become operational until checked by administrator). In one embodiment, the tag will be encrypted with a password that is different from other tags, such that only an authenticated reader can interpret it. The tag may also be advertised by the reader in its DHCP options to identify itself, in case DHCP is used for initial configuration. Special commands from the RF switch may be used to change the value of the tags as seen by any reader—e.g., change the ID to match newer password, and change configuration timestamp to force other readers seeing this tag to upgrade as desired.

Referring to the flowchart shown in FIG. 3 along with the example system shown in FIG. 2, the configuration process starts with initiation of the RFID reader (e.g., reader 108(a)). This initiation might include simply powering up the unit, or might include a specific “autoconfiguration” command issued automatically or by the operator. The phrase “initiate operation” is intended to encompass any operational mode of the RFID reader that is attended by the autoconfiguration procedure described herein.

In any event, when operation of RFID reader 108(a) is initiated, the reader scans (within its operational range 116(a)) for suitable configuration tags 210. If it finds such a tag, it reads any configuration code or other configuration information stored on the tag (step 304). If the tag is password protected, it will supply the needed password either automatically (i.e., by virtue of a preprogrammed password code entered during manufacturing) or request the password either through the network (shown in FIG. 1) or via a prompt supplied to the operator.

Next, in step 306, reader 108(a) selects a configuration file based on the configuration code or configuration information read from the configuration tag 210. The configuration file might be stored within reader 108(a) itself (and indexed according to configuration code), or may be requested from the network. If the configuration file is requested over the network, it may receive the file from any computer, server, or other host present on the network. In one embodiment, for example, the RF Switch 102 stores a list of such configuration files, and sends out the appropriate configuration file based on the configuration code. In the event that multiple types of configuration tags (with multiple codes) are present within the reader's range of operation, a suitable method of resolving this situation may be implemented—e.g., using some form of prioritization of codes.

Once the configuration file is selected and/or received, reader 108(a) implements the configuration file to configure itself (step 308). The reader may then be used in environment 202 immediately. In this way, readers may be replaced and configured quickly, with little or no administrator involvement.

Note that while the invention has been described in the context of configuring an RFID reader (such as a hand-held reader or a stationary reader), the present invention may be used in any device that includes an RFID reader, such as various mobile computers and the like.

The autoconfiguration method described above may be performed by any suitable combination of hardware, software, and firmware. In one embodiment, the procedure is performed by an “autoconfiguration module” within the reader, which consists of software code executed by one or more processors within the reader. It will be appreciated, however, that the autoconfiguration module is not so limited.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention ,as set forth in the appended claims and the legal equivalents thereof.

What is claimed is:

1. A method for automatic configuration of an RFID reader, the method comprising:
initiating operation of the reader;
reading configuration information from an RFID tag within an operational range of the reader;
selecting a configuration file based on the configuration information; and
configuring the reader using the configuration file.

2. The method of claim 1, wherein the configuration information comprises a configuration code.

3. The method of claim 1, wherein selecting the configuration file includes selecting the configuration file from a set of configuration files stored within the reader.

4. The method of claim 1, wherein the reader is configured to communicate with a host over the network, and wherein selecting the configuration file includes receiving the configuration file from the host over the network.

5. The method of claim 4, wherein the host is an RF switch.

6. The method of claim 1, wherein the configuration information on the RFID tag is password protected.

7. An RFID reader configured to autoconfigure itself during initial operation by reading configuration information from an RFID tag within its operational range, selecting a configuration file based on the configuration information, and configuring itself based on the configuration file.

8. The reader of claim 7, wherein the configuration information comprises a configuration code.

9. The reader of claim 7, wherein selecting the configuration file includes selecting the configuration file from a set of configuration files stored within the reader.

10. The reader of claim 7, wherein the reader is configured to communicate with a host over the network, and wherein selecting the configuration file includes receiving the configuration file from the host over the network.

11. The method of claim 10, wherein the host is an RF switch.

12. The method of claim 7, wherein the configuration information on the RFID tag is password protected, and the reader is configured to provide the password to read the configuration information.
